(19) United States
(12) Patent Application Publication
(10) Pub. No.: US 2002/0095469 A1
(43) Pub. Date: Jul. 18, 2002

(54) Network servers and methods of controlling network servers

(76) Inventors: Thorsten Laux, (US); Lars Oppermann, (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/025,166

(22) Filed: Dec. 19, 2001

(30) Foreign Application Priority Data
Dec. 22, 2000 (EP) 00128219.3

(51) Int. Cl. G06F 15/16

(52) U.S. Cl. 709/207; 709/205

(57) ABSTRACT

Methods, systems, and articles of manufacture consistent with the present invention send a document with a network address to a recipient, where it is determined to send the document to the recipient, a timer value is incorporated into the network address, and the document is sent with the incorporated network address to the recipient.

### CROSS-REFERENCE TO RELATED APPLICATIONS

This Application claims priority to the filing date of the following foreign patent application, which is incorporated herein by reference:

European Patent Application No. 00128219.3, entitled “NETWORK SERVER AND METHOD OF CONTROLLING A NETWORK SERVER”, filed on Dec. 22, 2000.

### FIELD OF THE INVENTION

The present invention relates to servers connected to networks, and in particular, the invention relates to servers supplying documents to networks.

### BACKGROUND OF THE INVENTION

It is known to provide network systems that include client computer systems and server computer systems. In a client/server architecture, the client computer system (e.g., a personal computer, work station, or other type of data processing device) is a requesting device and the server computer system is a supplying device, and both are connected via an appropriate communication network. In other words, the client computer system sends a request to the server computer system, and the server computer system processes this request, in order to output an appropriate response to the client computer system. A computer system acting as a server computer system in one instance may act as a client computer system in another, i.e. while in the one instance providing responses to requests (acting as a server computer system), a computer system may in another instance itself issue requests to another computer system (act as a client computer system).

The client/server architecture is widely used in a variety of computer networks, such as Local Area Networks (LAN), Metropolitan Area Networks (MAN), or Wide Area Networks (WAN). Another example of such a network is the Internet or the World Wide Web, where client computer systems send requests for documents, e.g. web pages, to server computer systems, which accordingly respond by sending the requested documents.

FIG. 1 depicts a schematic block diagram of an example network 2, to which a server computer system 70 and a client computer system 80 are connected. Only one client computer system and one server computer system are shown for simplicity, however, in a typical network, a large number of server computer systems will be connected to a large number of client computer systems. The client computer system can be any kind of suitable device having the capability of sending requests and receiving documents in response, such as a personal computer, a mobile telephone, or a personal digital assistant. As shown in FIG. 1, the server computer system typically comprises an operating system 71 and a server program 72 stored in a memory 70a, where the server program 72 contains a program logic for providing the server functionality, i.e. the functionality to appropriately respond to requests received from client computer systems.

As shown in FIG. 1, it is also known to provide so-called servlets 73 in a server computer system, where servlets are server-side applications that also provide some of the server computer system functionality. Examples of server programs used in the context of the Internet are Netscape and Apache. Servlets can, for example, be embodied as JAVA® servlets. In general, the server computer system functionality is provided by an appropriate combination of one or more server programs 72 and one or more servlets 73. Sun, Sun Microsystems, the Sun logo and JAVA are trademarks or registered trademarks of Sun Microsystems, Inc. in the United States and other countries. All other company and product names may be trademarks of their respective companies.

The term “server” in the context of the present application shall be used to refer to any appropriate combination of hardware (such as the server computer system 70) and software (such as the server program 72 and servlets 73) that provides the described server computer system functionality.

The server computer system 70 further comprises a storage medium 74, such as a hard disk drive, which stores documents 75 and document elements 76. The server outputs documents in response to requests, where the documents are retrieved from the storage medium or generated from documents elements 76 by appropriate procedures.

FIG. 1 also depicts a functional structure of the client computer system 80, which also comprises an operating system 81, and an appropriate client program 82 arranged to interact with the server program 72 and servlets 73 provided on the server computer system 70. An example of a client program is a network browser, such as an Internet browser.

As shown in FIG. 1 by the arrows, the client computer system 80, or more specifically the client program 82, outputs a request 201 to the server (e.g. a request for a web page). The server outputs an appropriate response 202 (e.g. the requested web page) to the client computer system. The network 2 and server are organized such that the server outputs specific documents, in response to requests from the client computer system, with the help of network addresses. In other words, a network address specifies or identifies a specific document on a specific server, such that a request containing such an address will result in the server outputting the corresponding document.

In principle, network addresses may have any appropriate structure. Typically, they have a structure as depicted in FIG. 2a, namely a first part 61 that identifies a server, and a second part 62 that identifies a specific document to be output by the server identified in the first part 61. It may be noted that FIG. 2a is a schematic representation of the logical structure of a network address, as it is possible that the physical elements of the network address (e.g. specific symbols) are mixed between the first part 61 and the second part 62, but identifiable by appropriate procedures. It is also possible that a network address has a physical form as shown in FIG. 2a, namely a first part 61 of contiguous symbols, and a second part 62 of contiguous symbols. An example of a network address having such a format is a URL (Uniform Resource Locator), which will be described in more detail below.

Routing elements (not shown) in the network 2 that forward the request from the client computer system 80 to the server computer system 70 typically consider the first part 61 identifying the server, to thereby transport the request to the appropriate server, while the server then identifies the document to be output by referring to the second part 62. The second part 62 can be generated in accordance with any appropriate coding scheme, but will have a hierarchical structure, where the hierarchical structure of the second part 62 is a reflection of the hierarchical storage of the filing structure in the storage medium 74 provided in the server computer system 70 identified by the first part 61.

An example of such a network address is the Uniform Resource Locator (URL) in the Internet. An example of a hypothetical URL is as follows:

http://www.example.com/directoryl/subdirectory1_{—}2/exampledocument.html

In the sample URL, the first portion up to the two slashes (i.e. “hftp:”) indicates the protocol of the server to be accessed. The portion following up to the next slash (“www.example.com”) is a domain name that identifies a server. The following portions (“directory1”, “subdirectory1_{—}2”) indicate a directory and subdirectory on that server. The final portion indicates a specific document name (“exampledocument.html”), which document is located in the subdirectory. The slashes (“/”) serve as delimiters for distinguishing between different portions and sub-portions of the URL.

With respect to the above-described first part 61 and second part 62, the portion “http://www.example.com” of the URL therefore corresponds to first part 61, and the remaining portion of the URL corresponds to second part 62.

It is noted that the above example is illustrative, as there is a large number of different protocols that can be indicated in the prefix besides the illustrated hypertext transport protocol (http), and there is also a wide variety of possibilities for forming domain names, e.g. with alternative extensions such as org and .gov.

Also, one server computer system may be a host to a plurality of domains, such that a plurality of domain names leads to a single server computer. It is also possible that a domain name leads to a gateway server, where the gateway server is a bridge from the illustrated network 2 to another second network (not shown) containing a plurality of servers associated with the second, distinct network. In this case, the first part 61, which leads to a specific server containing documents, will be longer than the domain name, and be specified by further addressing information.

A document output by a server can be a collection and combination of data elements, which will depend on the specific nature and purpose of the client/server network. For example, the World Wide Web, which operates on the Internet, is a system that operates with requesting and sending web pages, i.e. pages that contain text, pictures, and other data elements. Among such other data elements are hyperlinks, which are links to other web pages. A hyperlink comprises a specific URL (as an address or identifier of a specific web page), and if a user of the client computer system appropriately operates the client program (e.g. a web browser), then the client computer system sends out a request for obtaining the web page identified by the address comprised in the operated hyperlink. A hyperlink will typically appear in a highlighted fashion on a video display of the client computer system running the browser, or appear as an icon indicating a link. By clicking onto the icon or highlighted indication, the user invokes a process in the browser for requesting a web page having the address indicated by the hyperlink.

The purpose of hyperlinks is to simplify the use of computer systems for users of client programs such as browsers. Hyperlinks are well known in the art and need not be described in further detail here.

The embedding of hyperlinks into web pages, which may be created in accordance with a plurality of markup languages, such as HyperText Markup Language (HTML), Standard Generalized Markup Language (SGML), and Extensible Markup Language (XML), is described as an example. It is possible to insert addresses as link elements into any appropriate documents output by servers in a client/server network in which servers output documents in response to requests containing network addresses that identify documents.

It is desirable to provide an improved client/server network system.

### SUMMARY OF THE INVENTION

Methods, systems, and articles of manufacture consistent with the present invention provide for amending a network address that is within a document provided by a server to include additional information. In an example, the network address can be a URL and the document can be web page. When a client requests the server, such as a web server, to output the web page, the server amends the URL within the web page to include additional information. The additional information can be, for example, a time stamp, a counter value, a random number, or a server identifier. The amended network address, thus provides enhanced information that can then be used by the user. In the above-described example, if the URL is amended with a time stamp, the client can determine whether the retrieved web page is the most recent version.

This also provides a greater amount of control in the network. For example, in the above-described example, if the client sends another request for the web page using the amended URL that was in the web page, the server can determine whether the web page has been modified since the time stamp was amended to the URL. If the web page has been modified, then the server can output the modified web page.

In addition to web pages, the server can output other types of documents, such as, for example, text documents, spreadsheet documents, image documents, and sound files.

In accordance with methods consistent with the present invention, a method in a data processing system for sending a document with a network address to a recipient is provided. The method comprises the steps of: determining to send the document to the recipient; incorporating a timer value into the network address; and sending the document with the incorporated network address to the recipient.

In accordance with methods consistent with the present invention, a method in a data processing system comprising a web server having a web page with a URL is provided. The method comprises the steps performed by the web server of: receiving a request to download the web page to a client; determining whether the web page has been updated; when the web page has been updated, incorporating a time stamp into the URL of the web page; and downloading the web page with the URL incorporated with the time stamp to the client to satisfy the request; and when the web page has not been updated, downloading the web page to the client to satisfy the request.

In accordance with articles of manufacture consistent with the present invention, a computer-readable medium containing instructions that cause a data processing system to perform a method for sending a document with a network address to a recipient is provided. The method comprises the steps of: determining to send the document to the recipient; incorporating a timer value into the network address; and sending the document with the incorporated network address to the recipient.

In accordance with articles of manufacture consistent with the present invention, a computer-readable medium is provided. The computer-readable medium containing instructions that cause a data processing system comprising a web server having a web page with a URL to perform a method comprising the steps performed by the web server of: receiving a request to download the web page to a client; determining whether the web page has been updated; when the web page has been updated, incorporating a time stamp into the URL of the web page; and downloading the web page with the URL incorporated with the time stamp to the client to satisfy the request; and when the web page has not been updated, downloading the web page to the client to satisfy the request.

In accordance with systems consistent with the present invention, a data processing system is provided. The data processing system comprises: a secondary storage device having a stored document with a network address; a memory comprising a computer program that determines to send the document to a recipient, incorporates a timer value into the network address, and sends the document with the incorporated network address to the recipient; and a processing unit that runs the computer program.

In accordance with systems, a data processing system is provided. The data processing system comprises a web server having: a secondary storage device having a stored web page with a URL; a memory comprising a computer program that receives a request to download the web page to a client, determines whether the web page has been updated, when the web page has been updated, incorporates a time stamp into the URL of the web page and downloads the web page with the URL incorporated with the time stamp to the client to satisfy the request, and when the web page has not been updated, downloads the web page to the client to satisfy the request; and a processing unit that runs the computer program.

In accordance with systems consistent with the present invention, a data processing system for sending a document with a network address to a recipient is provided. The data processing system comprises: means for determining to send the document to the recipient; means for incorporating a timer value into the network address; and means for sending the document with the incorporated network address to the recipient.

In accordance with systems consistent with the present invention, a data processing system is provided. The data processing system comprises a web server having a web page with a URL, the web server having: means for receiving a request to download the web page to a client; means for determining whether the web page has been updated; means for incorporating a time stamp into the URL of the web page, when the web page has been updated; means for downloading the web page with the URL incorporated with the time stamp to the client to satisfy the request, when the web page has been updated; and means for downloading the web page to the client to satisfy the request, when the web page has not been updated.

In accordance with articles of manufacture consistent with the present invention, a computer-readable memory device encoded with a data structure and a program that accesses the data structure is provided. The program is encoded in the computer-readable memory device and run by a processor in a system. The data structure has a plurality of entries, each entry comprising: a network address that is contained in a document, wherein the program incorporates a time stamp into the network address before sending the document to a recipient.

The above-mentioned and other features, utilities, and advantages of the invention will become apparent from the following detailed description of the preferred embodiments of the invention together with the accompanying drawings.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a block diagram of a network containing a server computer system and a client computer system;

FIGS. 2a-2h depict block diagrams of address structures, in accordance with methods, systems, and articles of manufacture consistent with the present invention;

FIG. 3 depicts a block diagram of a client-server based data processing system with which embodiments of the present invention may be implemented;

FIG. 4 depicts a block diagram of a server computer system with which embodiments of the present invention may be implemented;

FIG. 5 depicts a block diagram of a data structure with which embodiments of the present invention may be implemented;

FIG. 6 depicts a block diagram of a server computer system connected to a network, in accordance with methods, systems, and articles of manufacture consistent with the present invention;

FIG. 7 depicts a schematic example of amending a network address with different address supplements, in accordance with methods, systems, and articles of manufacture consistent with the present invention;

FIG. 8 depicts a flow diagram illustrating the steps of outputting a document, in accordance with an embodiment of the present invention;

FIG. 9 depicts a flow diagram illustrating the steps of outputting a document, in accordance with another embodiment of the present invention;

FIG. 10 depicts a flow diagram illustrating the steps of outputting a document, in accordance with yet another embodiment of the present invention;

FIGS. 11a-11c depict flow diagrams illustrating the steps of amending a network address with an address supplement in accordance with embodiments consistent with the present invention; and

FIGS. 12a-12c depict a flow diagram illustrating an application of methods, systems, and articles of manufacture consistent with the present invention to a web server for providing web pages identified by URLs.

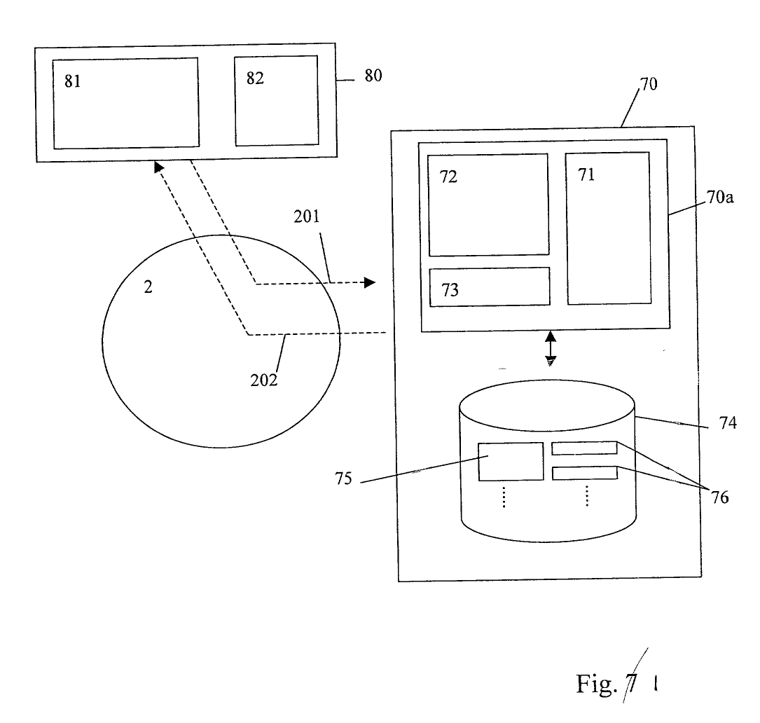

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

Methods, systems, and articles of manufacture consistent with the present invention provide for amending a network address that is within a document provided by a server to include additional information. As described above in an example, the server can be a web server that provides a web page (i.e. the document) to a client. The web page contains a network address, which is a URL. When the client requests the server to output the web page, the server amends the URL within the web page to include additional information. The additional information can be, for example, a time stamp, a counter value, a random number, or a server identifier. The amended network address, thus provides enhanced information that can then be used by the user and the server.

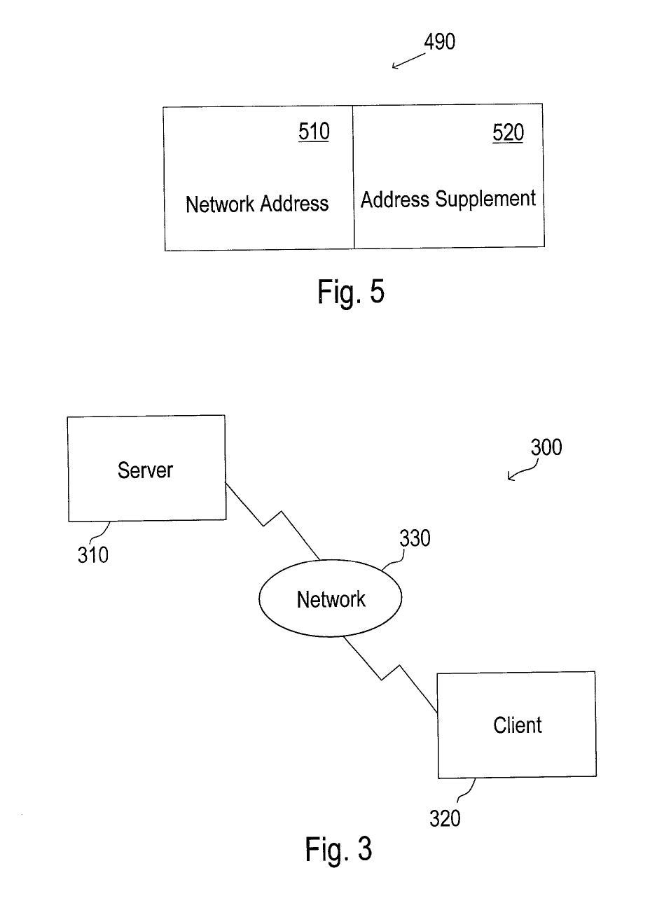

FIG. 3 depicts a block diagram of a client-server based data processing system 300 with which methods, systems, and articles of manufacture consistent with the present invention may be implemented. A server computer system 310 and a client computer system 320 are each connected to a network 330, such as a Local Area Network, Wide Area Network, or the Internet.

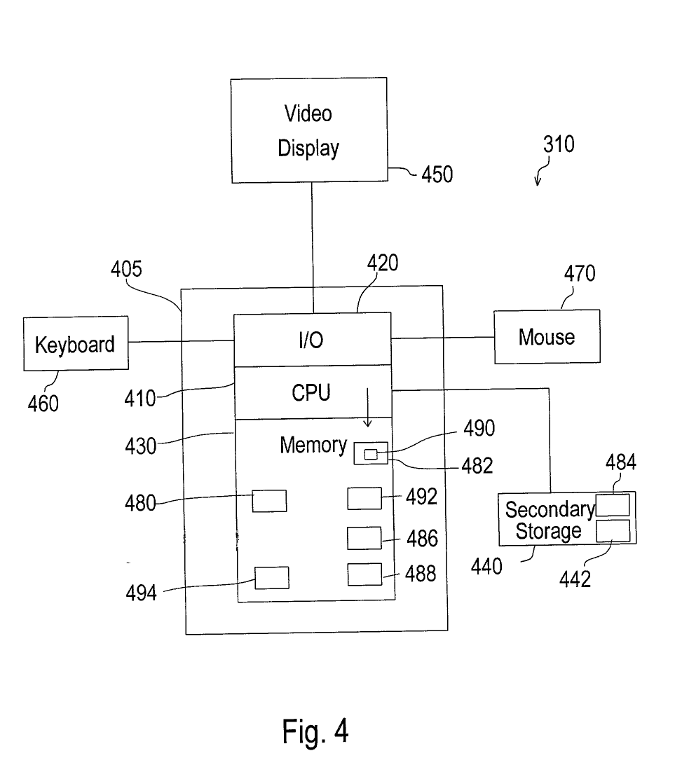

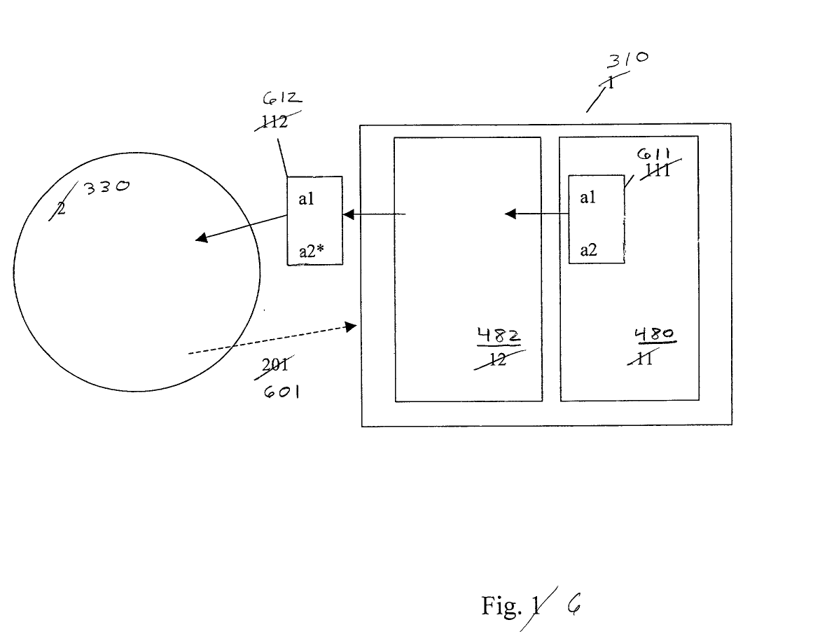

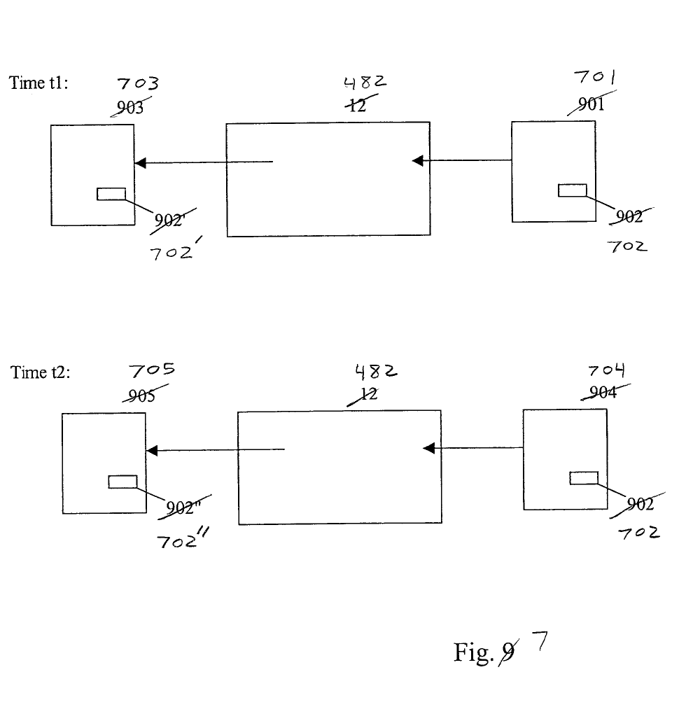

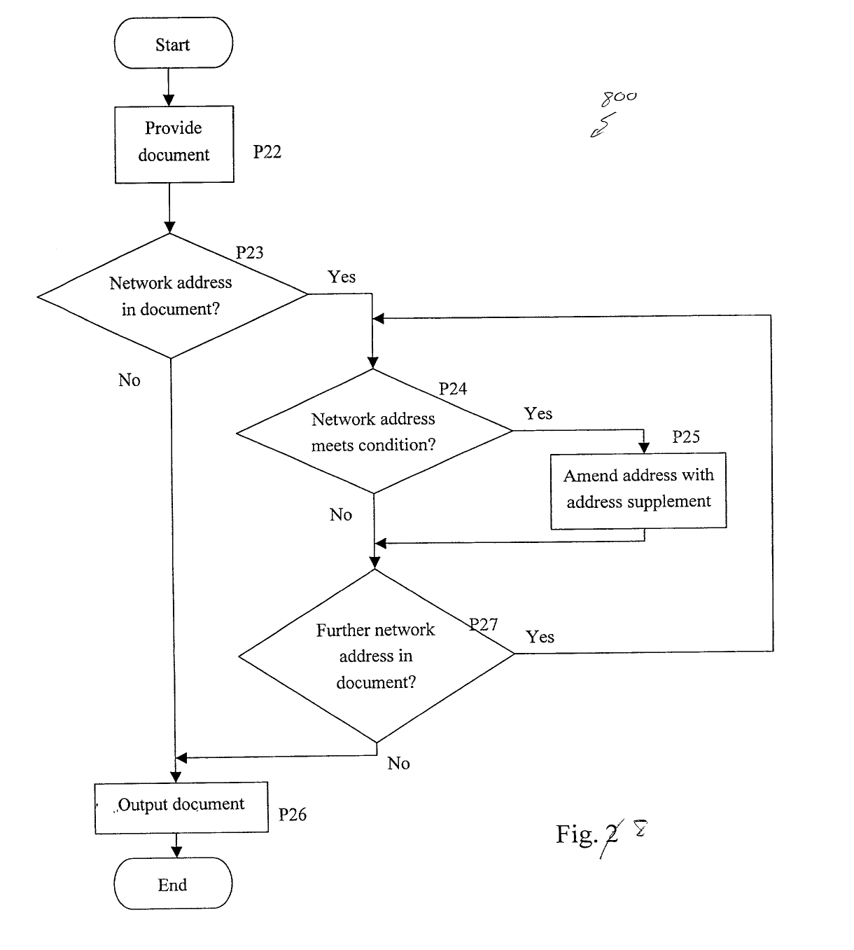

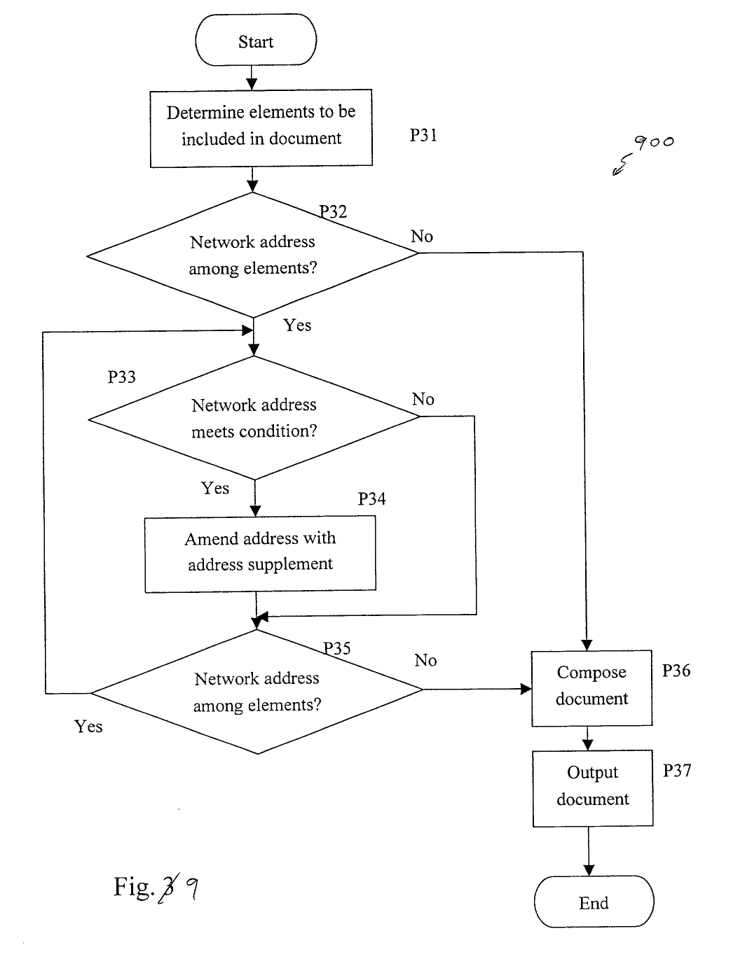

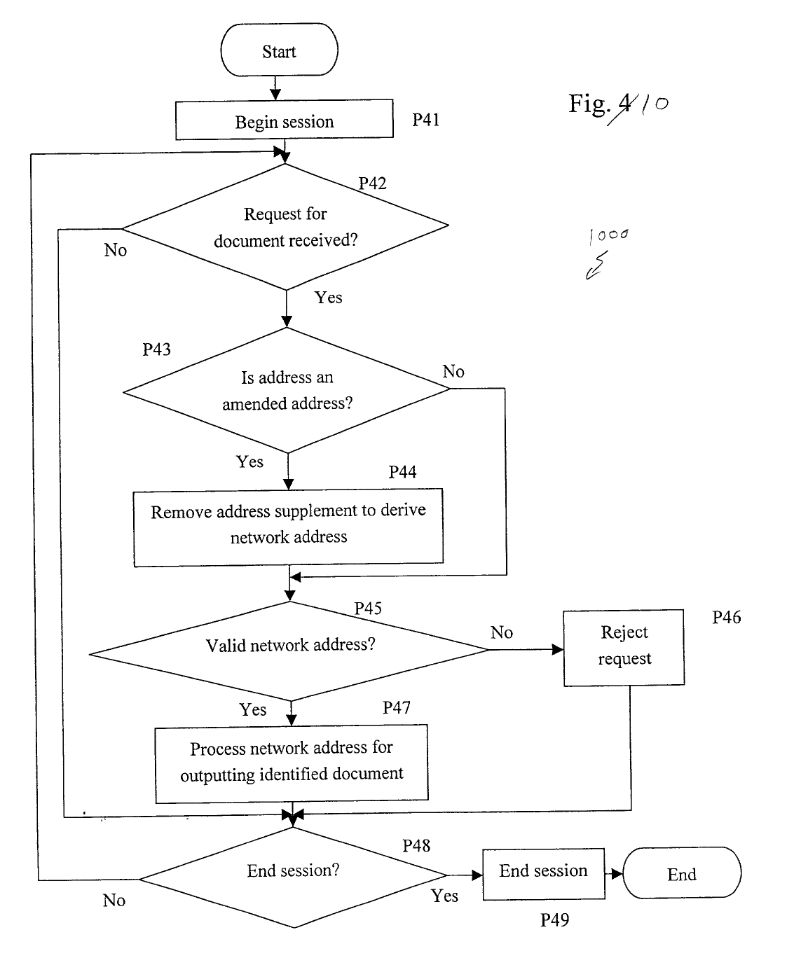

FIG. 4 depicts, in more detail, a block diagram of server computer system 310 of FIG. 3. Server computer system 310 comprises a central processing unit (CPU) 410, an input output I/O unit 420, a memory 430, a secondary storage device 440, and a video display 450. Server computer system 310 may further comprise standard input devices such as a keyboard 460, a mouse 470 or a speech processing means (not illustrated).

Memory 430 contains a document providing program 480 and an address amending program 482. Document providing program 480 provides documents that are on stored in secondary storage 440, where the documents are identified by network addresses. A sample document 484 is depicted in secondary storage 440 and will be described in more detail below. Address amending program 482 identifies specific network addresses that are included in documents (e.g. document 484) to be output by server 310 or are to be included in documents to be output, and amends such specific network addresses with an address supplement, if a predetermined condition is fulfilled. The predetermined condition may be single requirement or a plurality of requirements.

Document providing program 480 and address amending program 482 may comprise or may be included in one or more code sections containing instructions for performing their respective operations. While these programs are described as being implemented as software, the present implementation may be implemented as a combination of hardware and software or hardware alone. Also, one of skill in the art will appreciate that these programs may comprise or may be included in a data processing device, which may be a server, communicating with the server computer system 310. Document providing program 480 and address amending program 482 will be described in more detail below.

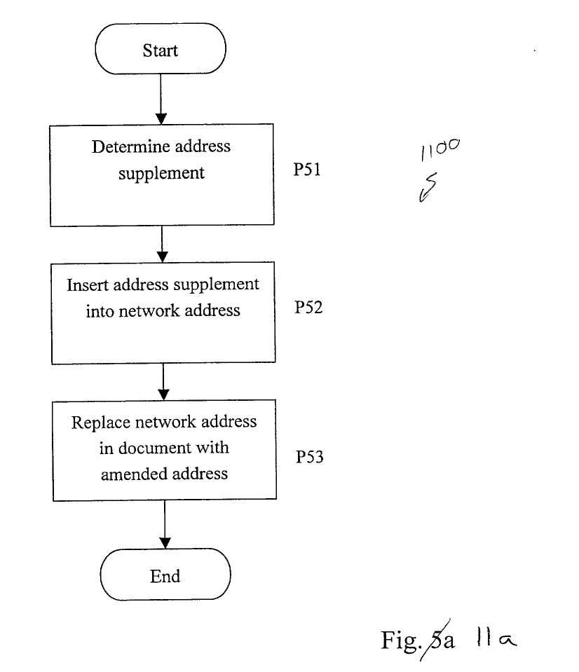

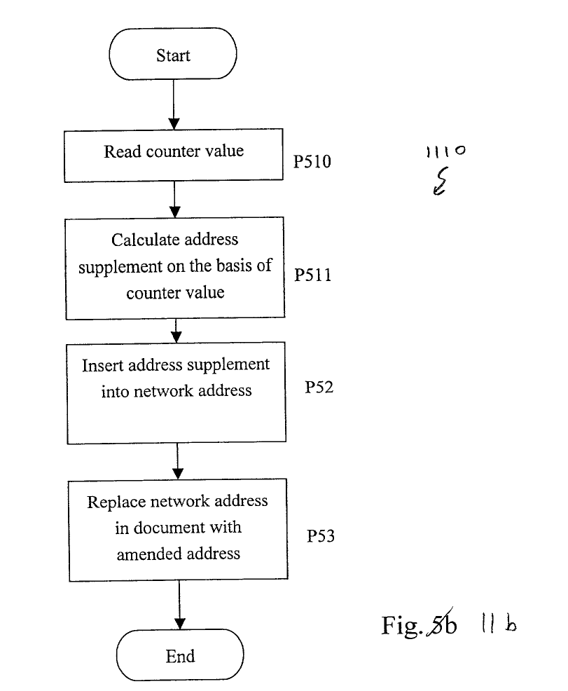

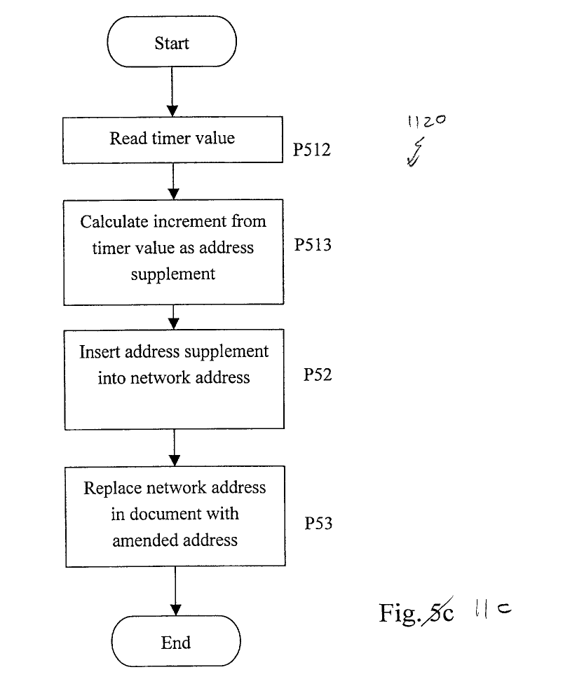

Address amending program 482 includes a data structure 490 having entries reflecting network addresses that are included in documents. FIG. 5 depicts a more detailed diagram of data structure 490. The sample data structure 490 that is depicted in FIG. 5 represents a network address. Data structure 490 comprises an original network address part 510 and an address supplement part 520, which is added by address amending program 482. As will be described in more detail below, address amending program 482 can amend additional parts to original network address part 510.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of client-server based data processing system 300 have been described, one skilled in the art will appreciate that a data processing system suitable for use with methods, systems, and articles of manufacture consistent with the present invention may contain additional or different components.

Further, server computer system 310 can comprise a plurality of servers connected via , for example, a network, the servers outputting documents that are identified by network addresses.

Referring back to FIG. 4, the described implementation of server computer system 310 includes a combination of hardware and software but the present implementation may be implemented as hardware alone or software alone. Additionally, server computer system 310 comprises one or more server programs 486 and one or more servlets 488, such as those described above. Document providing program 480 can, for example, be an appropriate code section in a program or code sections in a plurality of programs, where document providing program 480 calls up documents 484 stored in secondary storage 440, or comprises routines for generating documents on the basis of document elements 442 stored in secondary storage 440. In any case, server computer system 310 identifies documents to be output by network addresses. Therefore, the server computer system has a record of addresses 492 associated with the server in memory 430, and a means, such as a table, for identifying which document belongs to which address.

For example, if the server computer system is a web server, then documents to be output by the server computer system are identified by URLs, where the URLs have the above-mentioned hierarchical structure that reflects a hierarchical file structure, such that each URL indicates a specific path in a file structure stored in secondary storage 440 to a specific document to be output. The document can be, for example, a web page. The document can be any type of document, such as a text document, picture document, sound document, spread sheet document, or any other type or combination of document.

In an illustrative example, the server computer system may be a web server arranged to output documents that are web pages containing hyperlinks. Address amending program 482 may be arranged to identify if a network address (such as a URL) is part of a hyperlink, and to determine if the network address fulfills some supplementary condition, e.g. whether it is an address identifying a web page in the server computer system, or whether it is an address identifying a web page that belongs to a predetermined subgroup of web pages in the server computer system.

If address amending program 482 determines that one or more network addresses in the document fulfill the condition, then address amending program 482 amends the one or more addresses, and outputs the document with the amended addresses. This is shown schematically in FIG. 6, where a document 611 provided by the document providing program 480 contains two network addresses al and a2. In the example shown in FIG. 6, it is assumed that one of the network addresses (a2) fulfils the condition, and thus the address amending program 482 amends network address a2 to become an amended address a2*. The other network address (al) remains unchanged. Consequently, address amending program 482 outputs a revised document 612 containing network address al and amended address a2*. The amended address a2* is derived from network address a2, but also contains an address supplement generated locally by the address amending program 482 in the server computer system. Examples of this shall be explained in more detail below. The address amending program 482 outputs revised document 612 to network 330 in response to a request 601 from a client computer system via the network 330. The request typically identifies a document to be output and also identifies the requester (i.e. the client computer system), such that the server computer system can send a reply to the requester. Therefore, the server computer system sends revised document 612 to the requestor via network 330.

Although a document sent out by a server computer system will typically be output in response to a request, this is not always the case. Rather, it is also possible that a server computer system will output documents in response to an internal procedure, without having received a specific request for such a document. For example, if the network comprises a mailing functionality, it is possible that the server computer system is a mailing hub, which sends out documents to a large number of users/clients, without any of these users/clients having requested such a document.

As already mentioned, the documents to be output by the server computer system are identified by network addresses. In other words, document providing program 480 has the functionality to identify a document on the basis of the network address contained in the document, and to provide the identified document. Address amending program 482 is able to distinguish between network addresses and amended addresses in a received request. If an address is an amended address, then address amending program 482 removes the address supplement (i.e. discards the address supplement if it has served its purpose, or processes the address supplement further if it contains information of interest) to thereby derive the underlying network address, and then passes the network address to document providing program 480. The advantage of this arrangement is document providing program 480 need not be changed in any way. Consequently, address amending program 480 then additionally performs a type of filter function, namely to filter out address supplements from amended addresses it receives in requests.

On the other hand, such a structure may not necessary, as document providing program 480 may also contain the functionality of being able to identify documents on the basis of amended addresses, e.g. by itself having the capability of removing address supplements from received addresses.

In an example, the network addresses can be associated with link elements in documents and the server computer system amends the network addresses. Therefore, at least a part of the condition that leads to network addresses being amended by address amending program 482 is that a network address is contained in a link element. Link elements in documents are such elements that have a format so that a client computer system receiving the document may generate a request containing the network address associated with the link element. An example of such a link element is the well known hyperlink used in Web pages. A user of the client computer system can then request a web page belonging to the hyperlink by simply activating such a hyperlink, e.g. via a mouse click.

In this way, methods, systems, and articles of manufacture consistent with the present invention provide a further degree of freedom in the context of such client/server networks in which documents are identified by network addresses, because the individual server can introduce its own supplement into network addresses, which can provide numerous advantages, depending on the specific purpose and application.

For example, the address supplement can be used for identification purposes. Namely, the address supplement can be an identifier of the server computer system performing the amendment, or can be an identifier of the web page in which the amended address is contained. In this case, a server computer system receiving an amended address can identify the document being requested, and also identify from which server computer system the web page came in which the amended address was contained, or in which web page the amended address was contained. This can be useful for statistical purposes and for monitoring user behavior, as well as traffic behavior on the network, without having to directly monitor the network.

If the address supplement is used as an identifier, then typically the same address supplement will be used to identify the same entity. For example, if the address supplement serves to identify the server computer system performing the amendment, then address supplements added to network addresses by a given server computer system will be the same. Also, if the address supplement is to identify the document in which the amended address is contained, then the address amending program amends a network address with the same address supplement when a network address in that document is amended.

The predetermined condition that leads to a network address being amended or not depends on the purpose of the amendment. For example, in the above mentioned case where the address supplement serves to identify the server computer system performing the amendment, the predetermined condition will, for example, be the determination of whether the network address in the document belongs to a link element. Namely, address amending program 482 will amend network addresses in link elements by inserting its address supplements for identification. In this way, if the link element is actuated by a user/client, then a server computer system receiving the corresponding request can determine whether the request was generated on the basis of a link element in a document output by the server computer system that inserted its identifying address supplement.

The address supplement can also be used for making different amended addresses that are included in documents that follow one another, so that these subsequent amended addresses are distinguishable, even though the subsequent amended addresses are derived from a same network address. This is explained in more detail with reference to FIG. 7. In the upper part of FIG. 7, at a point in time t1, address amending program 482 processes a document 701 containing a network address 702, where the network address 702 fulfills a predetermined condition, such that address amending program 482 outputs a revised document 703 containing an amended address 702′. The bottom part of FIG. 7 depicts a point in time t2, where t2 is later than t1, and address amending program 482 is to output a document 704 containing the same network address 702. In this case, address amending program 482 again performs an amendment, but the amendment is done with a different address supplement, such that address amending program 482 outputs a revised document 705 containing an amended address 702″ that is different than the previous amended address 702′. Document 701 may be the same document as document 704, or it may be a different document.

Using the address supplement in such a way is useful in networks employing clients that have a caching function. An example of a client program having such a caching function are network browsers, such as browsers used for navigating in the Internet. Namely, such client programs typically store received documents in a cache directory, such that if a user of the client program would like to have a specific document, the client program does not immediately send a request to the appropriate server, but rather checks if the desired document is already stored in the cache directory. This is typically accomplished by keeping a record of all the addresses of the documents stored in the cache directory. Consequently, upon the user's action of requesting a specific document (e.g. by clicking a link element that is associated with a given address), the client program will check the record of cached documents by comparing the address of the desired document with the addresses of the cached documents. Typically, the addresses of the cached documents are kept in a separate table or record. If the client program determines a match between the desired address and a cached address, then the document is retrieved from the cache, and no request is sent to the server computer system. The purpose of such a functionality is to provide the user with a quicker response, and to avoid unnecessary network traffic.

In a typical system that uses the above-described caching function, when a document is updated on the server, it can happen that a client will desire a specific document but will receive an old version of the document from its local cache, instead of an up-to-date document from the server computer system.

Mechanisms are known for adjusting a client program (such as a browser) in such a way that either no caching takes place, or specific documents contain a mark telling the client program that this specific document should always be requested from the server computer system. Such mechanisms, however, work if the client program is appropriately adjusted, which can not be influenced by the server computer system. Methods, systems, and articles of manufacture consistent with the present invention provide a simple and effective mechanism for avoiding the above described problems. Namely, since address amending program 482 can provide different amended addresses in documents output subsequently to one another (where these documents may be different, i.e. may be identified by different network addresses, or be the same, i.e. identified by the same network address), the client program will never achieve a match with respect to cached documents, regardless of how the caching procedure is specifically implemented. According to one possibility, the client program keeps a record of the network addresses associated with received documents. In this case there will never be any match, as the amended addresses will be different from the network addresses for the same document. According to a second possibility, the client program keeps a record of cached documents on the basis of the address used for requesting said document. In this case, if the cached document was requested using an amended address contained in some other document (e.g. a hyperlink), then a subsequent document containing an amended address referring to the same original network address will be different from the recorded address at the client program, as explained in connection with FIG. 9. Consequently, there will again be no match.

Thus, regardless of a caching function being enabled or not, and regardless of the implementation of the caching function, the client program will request a document from the server computer system if the user actuates an amended address, such that it is possible to always provide the user with an up to date document. Methods, systems, and articles of manufacture consistent with the present invention thereby provide a simple mechanism according to which a server computer system can influence the behavior of a client program, such as a network browser, without directly having to perform any adjustments in the client program.

As noted earlier, the predetermined condition that a network address must fulfill in order to be amended depends on the specific application. Predetermined conditions can, for example, be that the network address is a part of a link element and that the network address identifies a specific document that is intended to be regularly updated. Therefore, an example implementation for performing the determination regarding the predetermined condition could comprise keeping a table 494 in memory 430, where table 494 identifies a group of documents to be provided by the server computer system. The group of documents in table 494 are the documents that are changed regularly, such that any client/user should request such a document from the server computer system, in order to receive a most up-to-date version.

Address amending program 482 can generate a variable address supplement on the basis of a variable data element. There are various possibilities for generating a variable data element for this purpose. For example, such a variable data element can be a counter value, where address amending program 482 uses a counter to count the events of amending addresses in documents that it outputs. In other words, address amending program 482 increments the counter value each time that an amended address is included in a document being output. Then address amending program 482 calculates the address supplement from the current counter value. Address amending program 482 determines an address amendment from the counter value such that different counter values lead to different address amendments. For example, address amending program 482 can use the counter value itself as an address amendment.

If the server computer system is arranged to conduct individual user sessions for individual users accessing services, then the server computer system can be arranged to keep individual counter values for each individual user, such that address amending program 482 uses the user counter value associated with a user requesting a document as a basis for generating address supplements for amending network addresses in documents to be sent to the user associated with that user counter value. Address amending program 482 can reset the user counter value to a predetermined value, such as 0, at the beginning of each user session.

Address amending program 482 can alternatively generate an address supplement using a timer value as a basis. In this case, address amending program 482 can use an internal clock of, for example, the server computer system as a basis for generating an address supplement that has the feature of being different for subsequent amended addresses relating to the same network address. For example, address amending program 482 can use the internal clock timer value itself as an address supplement. Such an internal clock timer value will typically be a multiple of a basic time unit, such as a millisecond, with the multiple identifying a time span from a predetermined starting date, such as Jan. 1, 1970, to the momentary point in time. If the use of such a value by address amending program 482 is impractical, e.g. due to the size of the value, it is possible for address amending program 482 to derive an address supplement as a time dependent increment, in which case, address amending program 482 divides the timer value by a number of time units corresponding to a predetermined period of time (e.g. the number of milliseconds corresponding to one week), and then uses an integer remainder value as an address supplement. In other words, address amending program 482 conducts a modulo operation. The use of a time increment entails the possibility that two subsequent address supplements might be identical, but if the period of time associated with the increment (e.g. one week, as mentioned above) is not too short, then the chance of such an event occurring is very small. Also, even if identical address supplements appear from time to time, this does not reduce the basic effect and usefulness of methods, systems, and articles of manufacture consistent with the present invention.

Further, address amending program 482 can incorporate additional information with the timer value or counter value address supplement. For example, address amending program 482 can incorporate a random number along with the timer value. Further, address amending program 482 can select a random number that has a value proportional to when the random number is generated. In other words, later generated random numbers will have greater values that earlier generated random number. The random number can, further, be based on a larger value.

Although the above-described embodiments used a counter value or a timer value as a basis for generating distinguishable address supplements, one of skill in the art will appreciate that other bases can be used. For example, address amending program 482 can derive the mentioned variable data element in another appropriate manner. Address amending program 482 can use any process that provides subsequently different values for generating subsequently different address supplements. The different values should be unique, although this is not necessary and it is sufficient if the probability of an occurrence of identical address supplements is not high. For example, address amending program 482 can generate address supplements using a random number or pseudo-random number generator, an incremented pointer to a cyclic table of sufficient length, or a hash function.

Although the above-described illustrative examples referred to cases where the address supplements are used for identification purposes or to ensure that client programs receive up-to-date documents, other uses are possible, depending on the specific desires and requirements. Also, it is possible to combine the identification feature and updating feature, e.g. by constructing address supplements with an identification part and a variable part.

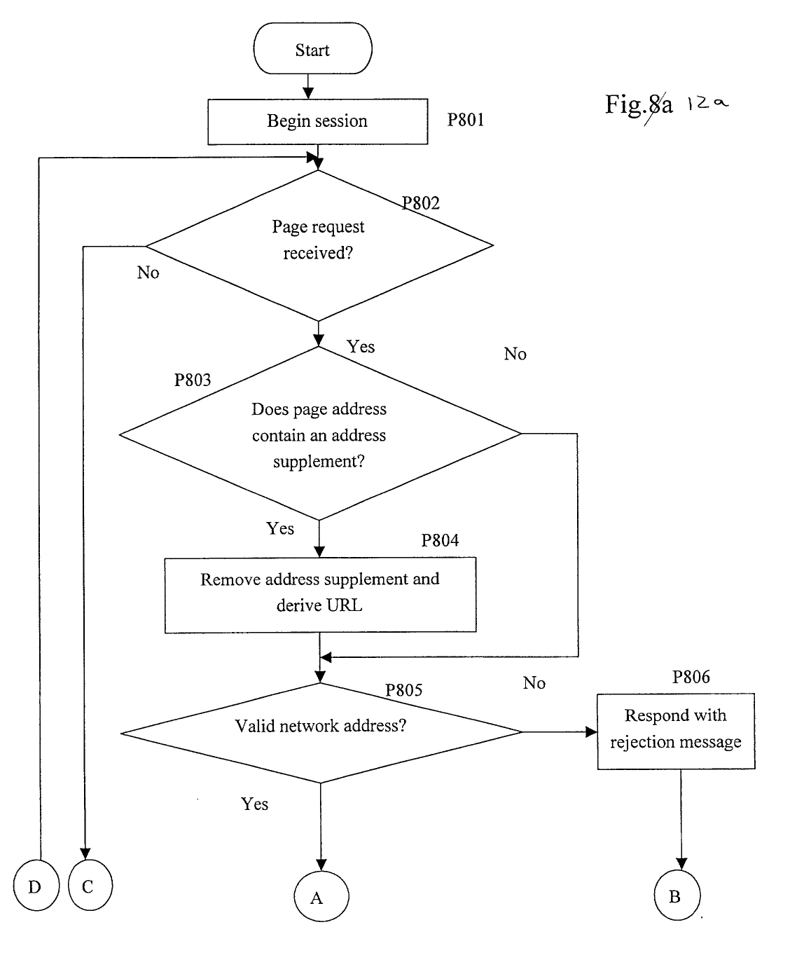

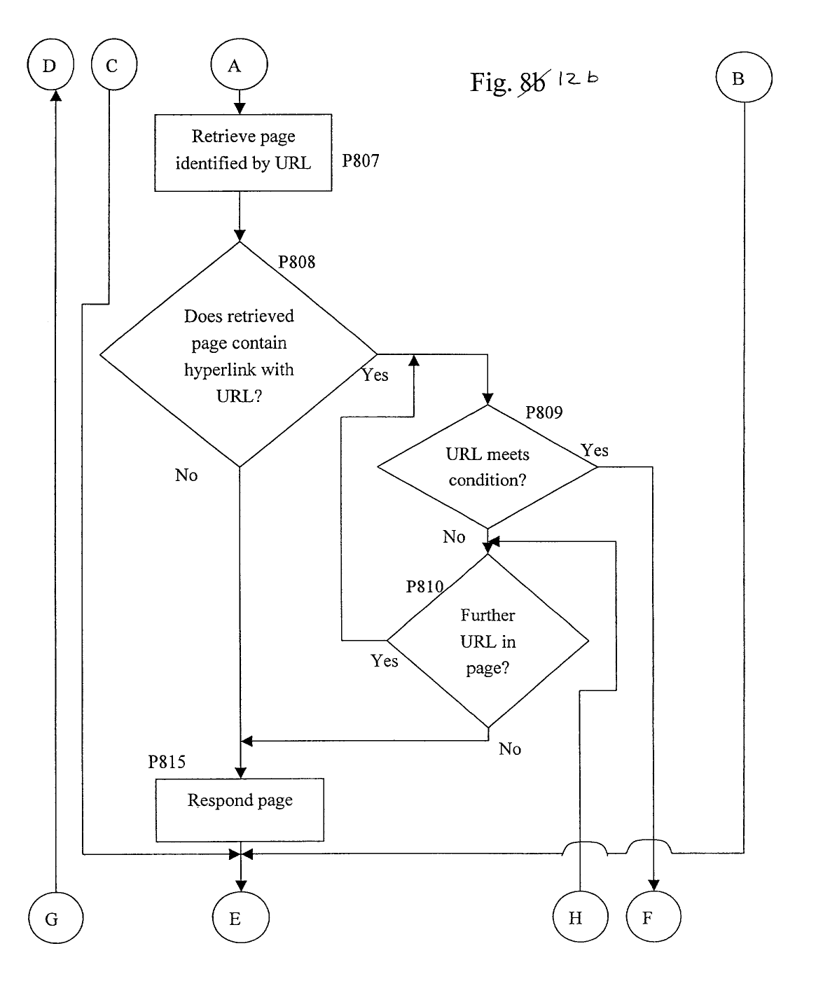

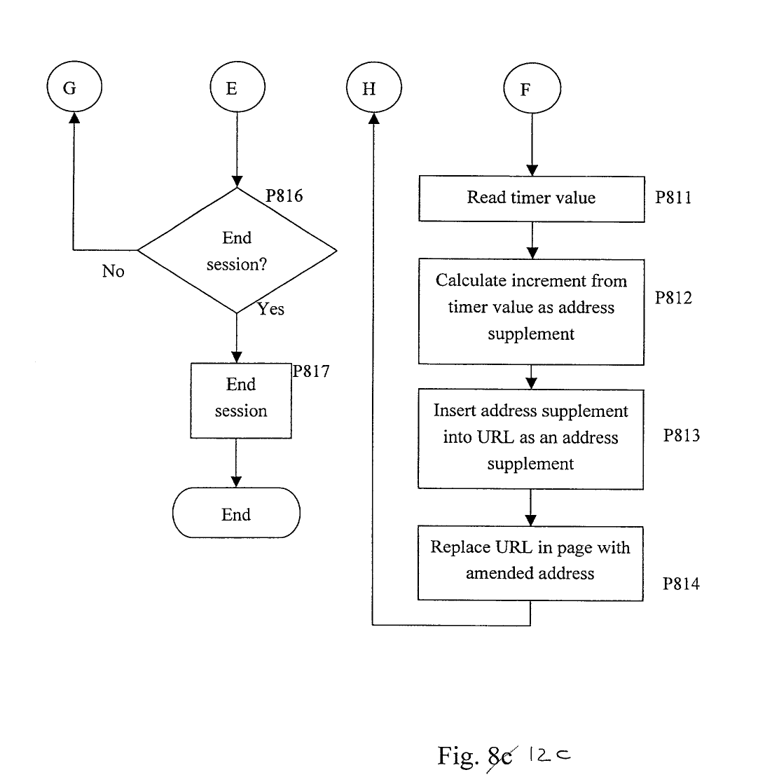

FIG. 8 depicts a flow diagram 800 illustrating exemplary steps for outputting documents from a server computer system in accordance with an embodiment consistent with methods, systems, and articles of manufacture consistent with the present invention. First, the document providing program provides a document, for example from secondary storage, to the address amending program (step P22). Then, the address amending program determines whether a network address is contained in the provided document (step P23).

If the address amending program determines that the document contains a network address in step P23, then the address amending program determines whether the network address meets a predetermined condition (step P24). The predetermined condition can be, for example, one of the predetermined conditions described above. If the address amending program determines that the network address meets the predetermined condition in step P24, then the address amending program generates an address supplement and amends the network address with the address supplement (step P25). The address amending program generates the address supplement according to one of the above mentioned possibilities.

If the address amending program determines in step P24 that the network address does not meet the predetermined condition or after the address amending program amends the network address in step P25, then the address amending program determines whether the document contains a further network address (step P27). If the address amending program determines in step P27 that the document contains a further network address, then the address amending program returns to step P24 to determine whether the network address meets a predetermined condition.

If the address amending program determines in step P23 that the document does not contain a network address or in step P27 that the document does not contain a further network address, then the address amending program outputs the document, possibly with amended addresses (step P26).

FIG. 9 depicts a flow diagram 900 illustrating exemplary steps for outputting documents from a server computer system in accordance with another embodiment consistent with methods, systems, and articles of manufacture consistent with the present invention. In the illustrated embodiment, the server computer system is arranged to compose and output documents from document elements stored on the server computer system. First, the document providing program determines which document elements are to be included in the document to be output and provides the document elements to the address amending program (step P31).

Then, the address amending program determines whether a network address exists among the document elements (step P32). If the address amending program determines that a network address exists among the document elements in step P32, then the address amending program determines whether the network address meets a predetermined condition (step P33). Examples of such predetermined conditions are discussed above.

If the address amending component determines that the network address does meets a predetermined condition in step P33, then the address amending component generates an address supplement and amends the network address with the address supplement (step P34).

After the address amending component amends the network address in step P34 or if the address amending component determines that the network address does not meet the predetermined condition in step P33, then the address amending component determines whether there is a further network addresses among the document elements (step P35). If there is not a further network address in step P35, then the address amending program returns to step P33 to determine whether the further network address meets a predetermined condition.

If the address amending program determines that there is a network address in step P32 or if the address amending program determines that there is not a further network address in step P35, then the address amending program composes the document for output including the document elements (step P36). The address amending program composes the document by, for example, sequentially combining the document elements into a single document. Composing documents from document elements is known in the art and is not described in more detail herein.

Then, the address amending program outputs the composed document (step P37).

As mentioned above, it is possible that the server computer system outputs documents without having received outside requests for documents, for example from a client computer system. The server computer system, however, typically provides documents in response to its receipt of outside requests. FIG. 10 depicts a flow diagram 1000 illustrating exemplary steps for processing requests and outputting documents as a response in a session-based system in accordance with an embodiment consistent with methods, systems, and articles of manufacture consistent with the present invention. First, the session begins (step P41). The beginning of the session can be initiated in a suitable manner, for example, by a user explicitly logging on to the server computer system, or by an implicit logon based on a first request containing some form of user/client identification.

Then, the document providing program determines whether a request for a document has been received (step P42). If the document providing program determines that a request has been received in step P42, then the address amending program determines whether a network address in the requested document is an amended address (step P43). An amended address is a network address that has been amended with an address supplement as generated in accordance with methods, systems, and articles of manufacture consistent with the present invention. If the address amending program determines that the network address is an amended address in step P43, then the address amending program removes the address supplement from the amended address, in order to derive the underlying network address (step P44).

If the address amending program determines that the network address is not an amended address in step P43 or after the address supplement is removed in step P44, then the address amending program determines whether the network address is a valid network address (step P45). The validity of a network address will depend on the specific situation and network, and can be determined, for example, on the basis of the format of the network address, or on the basis of its contents. For example, if a network address identifies a specific server computer system, but then does not identify any documents that the server computer system is capable of providing, then such a network address may be considered an invalid address by the address amending program.

If the address amending program determines that the network address is an invalid network address in step P45, then the request for a document is rejected (step P46). The rejection can comprise, for example, the address amending program sending a rejection message to the user that sent the request, where the rejection message may or may not contain an error indication, or alternatively a rejection of the request can also consist of the address amending program discarding the request, which means that no response is issued to the user.

If the address amending program determines that the network address is a valid address in step P45, then the address amending program amends the network address, in a manner as described above, and outputs the document (step P47).

If no document request is received by the document providing program in step P42, or after the request is rejected in step P46, or after the document is output in step P47, then the server computer system determines whether the session has ended (step P48). One of skill in the art will appreciate that the server computer system can make this determination in any suitable manner, such as receiving a request from the user to logout from the server computer system.

If the session has not ended in step P48, then the document providing program determines whether a request for a document is received in step P42. If the session has ended in step P48, then the server computer system ends the session (step P49).

FIG. 11a, 11b, and 11c depict flow diagrams 1100, 1110, and 1120, respectively, illustrating various embodiments comprising steps for amending addresses with address elements, such as in step P25 of FIG. 8 and in step P34 of FIG. 9.

Referring to FIG. 11a, first, the address amending program generates the address supplement (step P51). This has been explained above, and can, for example, comprise deriving an address supplement from a counter value or a timer value. Then, the address amending program inserts the address supplement into the network address (step P52). This process will be explained in more detail below with reference to FIGS. 6a-6h. Then, the address amending program replaces the network address in the document with the amended address (step P53).

With respect to the process 1100 depicts in FIG. 11a, step P51 can be omitted, namely in the specific case where the address supplement is a constant, as for example described above in the example where the address supplement is an identifier of the server computer system performing the amendment.

In FIG. 11b, the address amending program determines an address supplement based on a counter value, as described above. First, the address amending program reads a counter value (step 510). Then, the address amending program calculates an address supplement based on the counter value (step P511). The address amending program then inserts the address supplement into the network address (step P52). Then, the address amending program replaces the network address in the document with the amended address (step P53).

In FIG. 11c, the address amending program determines an address supplement based on a timer value, such as a value of the server computer system internal clock timer, as described above. First, the address amending program reads a timer value, for example, from the server computer system internal clock timer (step P512). Then, the address amending program calculates a time dependent increment from the timer value, as described above (step P513). The address amending program then inserts the address supplement into the network address (step P52). Then, the address amending program replaces the network address in the document with the amended address (step P53).

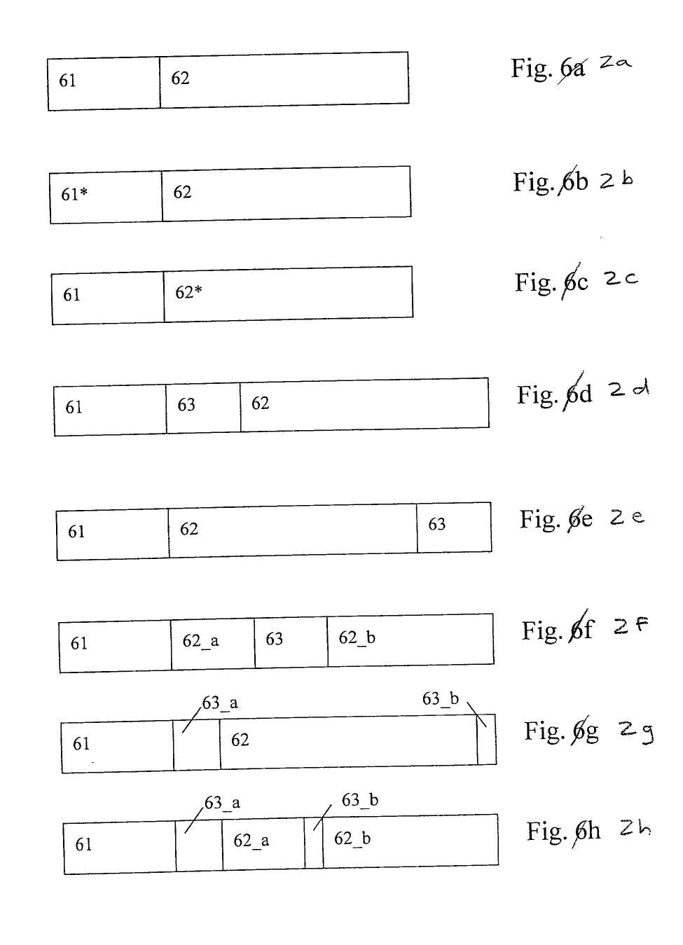

FIGS. 2a to 2h are now be referred to, in order to explain various illustrative examples of amending a network address with an address supplement. FIG. 2a shows a schematic representation of a network address, where the network address comprises a first part 61 that identifies a server computer system, and a second part 62 that identifies a specific document to be provided by the server computer system identified in the first part 61.

The address amending program can amend the network address in any suitable or desired manner. For example, as shown in FIG. 2b, the address amending program can convert the first part 61 into an amended first part 61*, where the address amending program generates the amended first part 61* by amending the first part 61 of the network address with the address supplement. An alternative is shown in FIG. 2c, in which case, the address amending program converts the second part 62 of the network address into an amended second part 62* by amending the second part 62 with the address supplement. Although not shown, the address amending program can also generate an amended address by amending both the first part 61 and the second part 62.

As mentioned above, although it is possible to amend the first part 61 that identifies a specific server computer system, this leads to the necessity of updating routers in the network, such that the amended addresses can be handled by the routers. Thus, by amending the second part 62 and not the first part 61, the network routing process is not influenced.

Also, for the purpose of simplicity, the address amending program can perform the amending of the network address by inserting or adding an appropriate data element to the network address. As shown e.g. in FIG. 2d, the address amending program inserts the address supplement 63, as a data element, between the first part 61 and the second part 62. In other words, the first part 61 remains unchanged, and the part following the part 61, which would conventionally be regarded as the identifier of a specific document on the server computer system identified in first part 61, becomes a “new” part consisting of the original second part 62 and the address supplement 63. Further, the address amending program can add the address supplement 63 at the end of the second part 62, as shown in FIG. 2e. Also, arbitrary configurations can be chosen for generating a part that follows the first part 61, where FIG. 2f shows an example, in which the address amending program divides the original second part 62 into a first element 62_{—}a and a second element 62_{—}b, where these two elements are separated by the address supplement 63. FIG. 2g shows a case where the address amending program separates the address supplement into two parts 63_{—}a and 63_{—}b, respectively provided before and after the original second part 62. FIG. 2h shows a mixed case of FIGS. 2f and 2g, in which the address amending program separates both the original second part 62 and the address supplement into respective parts 63_{—}a, 63_{—}b and 62_{—}a, 62_{—}b.

The configurations described in connection with FIGS. 2a to 2h can be used in connection with any type or system of addressing. In the following, a few examples shall be given for the case where the network addresses are URLs. Referring to FIG. 2d as an example, the address amending program can amend an original URL such as

http://www.example.com/destination.doc

by inserting a data element consisting of a predetermined number of digits, e.g. 8 digits, such as “abcd0345”, in order to generate

http://www.example.com/abcd0345/destination.doc

This is merely an illustrative example. The address supplement can be any arbitrary combination of characters or symbols, and can be a number, a string or a combination of a number and string. For example, when using a counter value or a timer value as a basis, the address supplement will typically be a number. Also, the address supplement can have more or less than 8 digits. Furthermore, the address supplements can have a variable length.

The address supplements can have a predetermined format, such as a starting delimiting symbol and an ending delimiting symbol, such that the beginning and end of an address supplement can be determined by a server computer system. For example, one convention that is used is that the address supplement is added after the first slash (“/”) to follow the “<protocol>://”-indication in a URL, and that the address supplement ends at the next slash. In this way, the address supplement replaces the first subdirectory indication in a URL. As a consequence, a server computer system can identify a network supplement (and thereby an amended address) by first determining whether the indication following the first slash is a valid directory, and if not, extracting the expression between the two slashes, to thereby generate a normal URL, e.g. a conventional network address.

In addition, if a URL contains an application name, e.g. a servlet name that follows the domain indicator, such as

http://www.example.com/servlet_name/directory_{—}1/destination.doc

it is possible to insert the address supplement behind the application indicator, such as

http://www.example.com/servlet_name/6353745/directory_{—}1/destination.doc

where “635374” indicates an address supplement in this example. Therefore, the address supplement again replaces the first subdirectory indication.

In an alternative in connection with URLs, the address amending program adds the data element having a predetermined format and structure at the end of each URL, as shown in FIG. 2e. Accordingly, a server computer system is then able to check if there is a data element after the last indication (the file indicator, e.g. “destination.doc” in the example above) in a received address, and if so, extracts this predetermined structure and possibly processes it further, e.g. for identification purposes. It is to be understood that mixed concepts, such as those shown in FIG. 2f to 2h, are equally applicable for URLs.

Now an embodiment in accordance with methods, systems, and articles of manufacture consistent with the present invention shall be explained with respect to FIGS. 12a-12c, where the routine shown in FIGS. 12a-12c constitutes a specific example of the routines shown in FIGS. 8, 10, 11a-11c, for the specific case of a web server arranged to provide web pages. In the example, the web pages are prepared in any known web page format, such as SGML (Standard Generalized Markup Language), the HyperText Markup Language (HTML), or the eXtensible Markup Language (XML). The network addresses are URLs. The routine starts with the beginning of a session (step P801). Then, the document providing program determines whether a page request has been received (step P802). A page request is a message containing an URL identifying the server computer system. In other words, it is for example a URL like the one shown above. If the document providing program determines that a page request has been received in step P802, then the address amending program determines whether a network address in the requested page contains an address supplement (step P803). If the address amending program determines that the network address contains an address supplement in step P803, then the address amending program removes the address supplement from the network address and derives the original URL (step P804).

After the address amending program derives the original URL in step P804 or determines that the page does not contain an address supplement in step P803, then the address amending program determines whether the URL is a valid network address for the server computer system (step P805). In other words, the address amending program determines whether the URL has a valid format, and whether it identifies a document that the server computer system is arranged to output. If the address amending program determines that the URL is not a valid network address in step P805, then the address amending program outputs a response to the requester with a rejection message (step P806).

If the address amending program determines that the URL is a valid network address in step P805, then the document providing program retrieves the web page identified by the URL, for example, from secondary storage (step P807). Then, the address amending program determines whether the retrieved web page contains a URL (step P808).

If the address amending program determines that the retrieved web page contains a URL in step P808, then the address amending program determines whether the URL contained in the retrieved web page identifies a web page belonging to a group of web pages that should be kept up to date (step P809). If the URL belongs to this group, then the address amending program reads a timer value (step P811), then calculates a time dependent increment (step P812), then inserts the time dependent increment into the URL as an address supplement (step P813), and replaces the URL in the retrieved page with the amended address (step P814).

If the address amending program determines that the URL does not belong to the group in step P809, or after the address amending program replaces the URL in the retrieved web page in step P814, then the address amending program determines whether there is a further URL in the retrieved web page (step P810).

If the address amending program determines that there is a further URL, then the address amending program returns to step P809. If the address amending program determines that there is not a further URL in step P810 or that the retrieved page does not contain a URL in step P808, then the address amending program outputs the (possibly amended) web page (step P815).

If the address amending program determines that a page request has not been received in step P802 or has responded with a rejection message in step P806 or has output the web page in step P815, then the server computer system determines whether the session is to be ended (step P816). If the session is not to be ended in step P816, then the document providing program determines whether a page request is received in step P802. If the session is to be ended in step P816, then the server computer system ends the session (step P817).

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A method in a data processing system for sending a document with a network address to a recipient, the method comprising the steps of:
determining to send the document to the recipient;
incorporating a timer value into the network address; and
sending the document with the incorporated network address to the recipient.

2. The method of claim 1, wherein the recipient is a computer.

3. The method of claim 1, wherein the recipient is a program in the data processing system.

4. The method of claim 1, wherein the address supplement is based on a time dependent increment.

5. The method of claim 1, further comprising the step of:
generating the document from a plurality of document elements stored in the predetermined server.

6. The method of claim 1, wherein the network address has a format such that a first part of the network address identifies a server in the network, and a second part of the network address identifies the document, which is sent by the server identified by the first part, and wherein the timer value is incorporated into the second part.

7. The method of claim 1, wherein the network is an Internet and the network address is a Uniform Resource Locator.

8. The method of claim 1, wherein the document is a web page and the network address is a URL.

9. The method of claim 1, wherein the network is one of a Local Area Network, a Metropolitan Area Network, and a Wide Area Network.

10. The method of claim 1, wherein the network address is within the document.

11. The method of claim 1, further comprising the step of:
determining whether the network address meets a predetermined condition, wherein the network address is incorporated based on the network address meeting the predetermined condition.

12. The method of claim 11, wherein the predetermined condition is met if the network address comprises a link element, the link element having a format such that the link element can be used by a user of the network who receives a document containing the link element in order to generate a request containing the network address associated with the link element.

13. The method of claim 1, further comprising the step of:
receiving a request for the document, wherein the document is sent in response to the received request, the request comprising one of a network address identifying the document and an amended network address derived from a network address identifying the document.

14. The method of claim 13, further comprising the steps of:
determining whether the received request comprises a network address or an amended network address;
when the received request comprises an amended network address, deriving a network address from the amended network address by removing an address supplement from the amended network address, the outputted document being identified by the derived network address.

15. A method in a data processing system comprising a web server having a web page with a URL, the method comprising the steps performed by the web server of:
receiving a request to download the web page to a client;
determining whether the web page has been updated;
when the web page has been updated,
incorporating a time stamp into the URL of the web page; and
downloading the web page with the URL incorporated with the time stamp to the client to satisfy the request; and
when the web page has not been updated,
downloading the web page to the client to satisfy the request.

16. A computer-readable medium containing instructions that cause a data processing system to perform a method for sending a document with a network address to a recipient, the method comprising the steps of:
determining to send the document to the recipient;
incorporating a timer value into the network address; and
sending the document with the incorporated network address to the recipient.

17. The computer-readable medium of claim 16, wherein the recipient is a computer.

18. The computer-readable medium of claim 16, wherein the recipient is a program in the data processing system.

19. The computer-readable medium of claim 16, wherein the address supplement is based on a time dependent increment.

20. The computer-readable medium of claim 16, further comprising the step of:
generating the document from a plurality of document elements stored in the predetermined server.

21. The computer-readable medium of claim 16, wherein the network address has a format such that a first part of the network address identifies a server in the network, and a second part of the network address identifies the document, which is sent by the server identified by the first part, and wherein the timer value is incorporated into the second part.

22. The computer-readable medium of claim 16, wherein the network is an Internet and the network address is a Uniform Resource Locator.

23. The computer-readable medium of claim 16, wherein the document is a web page, and the network address is a URL.

24. The computer-readable medium of claim 16, wherein the network is one of a Local Area Network, a Metropolitan Area Network, and a Wide Area Network.

25. The computer-readable medium of claim 16, wherein the network address is within the document.

26. The computer-readable medium of claim 16, further comprising the step of:
determining whether the network address meets a predetermined condition, wherein the network address is incorporated based on the network address meeting the predetermined condition.

27. The computer-readable medium of claim 26, wherein the predetermined condition is met if the network address comprises a link element, the link element having a format such that the link element can be used by a user of the network who receives a document containing the link element in order to generate a request containing the network address associated with the link element.

28. The computer-readable medium of claim 16, further comprising the step of:
receiving a request for the document, wherein the document is sent in response to the received request, the request comprising one of a network address identifying the document and an amended network address derived from a network address identifying the document.

29. The computer-readable medium of claim 28, further comprising the steps of:
determining whether the received request comprises a network address or an amended network address;
when the received request comprises an amended network address, deriving a network address from the amended network address by removing an address supplement from the amended network address, the outputted document being identified by the derived network address.

30. A computer-readable medium containing instructions that cause a data processing system comprising a web server having a web page with a URL to perform a method comprising the steps performed by the web server of:
receiving a request to download the web page to a client;
determining whether the web page has been updated;
when the web page has been updated,
incorporating a time stamp into the URL of the web page; and
downloading the web page with the URL incorporated with the time stamp to the client to satisfy the request; and
when the web page has not been updated,
downloading the web page to the client to satisfy the request.

31. A data processing system comprising:
a secondary storage device having a stored document with a network address;
a memory comprising a computer program that determines to send the document to a recipient, incorporates a timer value into the network address, and sends the document with the incorporated network address to the recipient; and
a processing unit that runs the computer program.

32. The data processing system of claim 31, wherein the recipient is a computer.

33. The data processing system of claim 31, wherein the recipient is a program in the data processing system.

34. The data processing system of claim 31, wherein the network is an Internet and the network address is a Uniform Resource Locator.

35. The data processing system of claim 31, wherein the document is a web page and the network address is a URL.

36. The data processing system of claim 31, wherein the network is one of a Local Area Network, a Metropolitan Area Network, and a Wide Area Network.

37. A data processing system comprising:
a web server having:
a secondary storage device having a stored web page with a URL;
a memory comprising a computer program that receives a request to download the web page to a client, determines whether the web page has been updated, when the web page has been updated, incorporates a time stamp into the URL of the web page and downloads the web page with the URL incorporated with the time stamp to the client to satisfy the request, and when the web page has not been updated, downloads the web page to the client to satisfy the request; and
a processing unit that runs the computer program.

38. A data processing system for sending a document with a network address to a recipient, the data processing system comprising:
means for determining to send the document to the recipient;
means for incorporating a timer value into the network address; and
means for sending the document with the incorporated network address to the recipient.

39. A data processing system comprising:
a web server having a web page with a URL, the web server having:
means for receiving a request to download the web page to a client;
means for determining whether the web page has been updated;
means for incorporating a time stamp into the URL of the web page, when the web page has been updated;
means for downloading the web page with the URL incorporated with the time stamp to the client to satisfy the request, when the web page has been updated; and
means for downloading the web page to the client to satisfy the request, when the web page has not been updated.

40. A computer-readable memory device encoded with a data structure and a program that accesses the data structure, the program encoded in the computer-readable memory device and run by a processor in a system, the data structure having a plurality of entries, each entry comprising:
a network address that is contained in a document, wherein the program incorporates a time stamp into the network address before sending the document to a recipient.

41. The computer-readable memory device of claim 40, wherein the document is a web page and the network address is a URL.
